(19) United States
(12) Patent Application Publication
(10) Pub. No.: US 2022/0230116 A1
(43) Pub. Date: Jul. 21, 2022

(54) AUTOMATED SCORING OF CALL INTERACTIONS

(71) Applicant: MINDTICKLE, INC., San Francisco, CA (US)

(72) Inventors: Ajay DUBEY, Bhopal (IN); Aseem KHARE, Indore (IN); Himanshu BANSAL, Meerut (IN); Neeraj SANGHVI, Mumbai (IN); Rahul AGRAWAL, Ahmedabad (IN); Rajat SINGH, Azamgarh (IN); Vishal SHAH, Pune (IN)

(21) Appl. No.: 17/192,485

(22) Filed: Mar. 4, 2021

(30) Foreign Application Priority Data
Jan. 21, 2021 (IN) 202121003076

(51) Int. Cl. G06Q 10/06; H04M 3/51; G10L 15/26

(52) U.S. Cl. CPC G06Q 10/06393; G10L 15/26; H04M 3/5175; G06Q 10/06398

(57) ABSTRACT

Systems and methods for automatically scoring a call interaction include receiving and recording a call interaction between a customer and an employee of an organization; converting the call interaction into text; scoring the call interaction based on a plurality of parameters associated with what the employee spoke and a plurality of parameters associated with how the employee spoke; generating remarks based on the score of the call interaction; determining performance of the employee based on the score and the remarks of the call interaction; and displaying the score and the remarks of the call interaction on a user device to improve the performance of the employee.

### TECHNICAL FIELD

The present disclosure relates to providing insight into various call interactions, such as conversations, customer calls and client meetings. Specifically, the present disclosure describes a methodology and process to derive a score for a call interaction from the transcription and recording of the call interaction.

### BACKGROUND

Conversations contain a plethora of information as multiple parties gather and discuss details on products and services. These conversations are generally recorded in many organizations. There are many reasons for businesses to record calls, although most revolve around using the recordings as coaching and quality assurance tools to drive higher-quality customer experiences. The type of calls most often recorded include: a) sales calls; b) client meetings; c) webinars; d) training and coaching calls; and e) customer service and support calls. Most companies transcribe these calls after recording as well to allow an employee to reflect on his/her performance and for managers to give feedback on the employee's performance. This process is most commonly observed in sales calls and client meetings.

The challenge, however, is the manual intervention required in reviewing all conversations by managers and leaders at scale. It is difficult to unlock the hidden insights from the calls due to the very subjective nature of these discussions.

Currently, there is no technology that automatically evaluates and scores a call. There are technologies that allow managers to evaluate calls manually, by listening to the calls individually and completing forms. This, however, is troublesome and time-consuming, since the manager now needs to look at every call and decipher whether it was good or not. The manager can then make a judgment whether the employee is performing well, and in case of sales, the manager can judge whether the deal could close or not. This results in huge amounts of time spent by the manager.

Accordingly, a need exists for improved methods and systems for analyzing and scoring call interactions.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a call center according to various aspects of the present disclosure.

FIG. 2 is a flowchart of method of automatically scoring a call interaction according to various embodiments of the present disclosure.

FIG. 3 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various software, machine learning, mechanical, compositional, structural, electrical, and operational changes may be made without departing from the spirit and scope of this description and the claims. In some instances, well-known machine logic, circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present disclosure solves the above-mentioned problems by bringing in an objective measure for a call interaction and associating a score with each call interaction. A “call interaction” as used herein means an oral communication between a customer and an employee of an organization or a company, irrespective of the mode of transmission (e.g., telephone, videoconference, web chat, or any other mode of voice exchange(s)). “Employee” is meant to encompass an individual hired by a company or organization to perform a set job. Examples of employees include customer service representatives, sales representatives, contractors, and consultants. Examples of call interactions include sales calls, client meetings, webinars, training and coaching calls, web conferences, and customer service and support calls. Multiple parameters based on what an employee spoke and how the employee spoke are taken into account while calculating the score of the call interaction. According to certain embodiments, each score is then compared to thresholds, standards, or targets defined by the company in guidance with industry standards and then a weighted average of the score of each parameter is taken into account in calculating the score of the call interaction. Based on the final score, subjective remarks are also provided for the call interaction to help get an understanding of whether the call interaction was good or not. For example, the final score can provide an indication of whether the employee is following protocol or company procedures, whether the employee provided satisfactory customer service, and/or whether a sale is a likely outcome of the call interaction. In some embodiments, whether the call interaction was good (e.g., acceptable) or not is determined relative to other call interactions so that leaders and managers can quickly pinpoint the employees that need training and coaching, and even rank those needing the most or specific types of training or coaching. Amongst the variety of call interactions that get recorded and scored, the present disclosure can be used across all types of calls, including sales calls and client meetings, and training and coaching interactions.

Advantageously, the present disclosure allows managers and leaders to get a quick summary of which call interactions were good or which were not good based on the score, so the manager can focus on areas of improvement and coach the employees on specific areas. The manager no longer needs to listen to all call interactions, and the focus area can be accordingly reduced to a significantly smaller set of call interactions to review. Moreover, the present systems and methods allow the managers and leaders to decipher aspects of the employee's soft skills that cannot be understood only by listening to calls, and more objectively compared to the employee's own progress and that of other employees.

The present systems and methods are useful for all customer facing teams, including: a) sales teams; b) customer success teams; c) professional services teams; and d) customer support teams. For each type of team, scoring of the call interactions would be useful for a) managers; b) leaders c) enablers and trainers; and d) customer facing representatives. Managers receive objective insights about an employee's performance on a call interaction and across call interactions. This allows managers to coach or train their employees on specific gaps that can be more easily and more objectively identified via the disclosed systems and methods. It also allows managers to know when and where their intervention is needed in terms of priority and urgency. It can further save significant time by reducing the need to review every call. Enablers and trainers understand what a successful call looks like and which employees are better performing people on the field, but reviewing every single interaction is not feasible particularly considering the time and cost. Understanding the winning behaviors of the team, and the individual strengths of the members thereof on that team, helps create strategies and training materials that increase overall performance of the team to deliver better customer experience(s). Customer facing representatives can more ideally understand their own performance on a call interaction. Based on this, the user of the present systems is better prepared to draft the relevant follow-up emails to keep a customer engaged on a future interaction, to increase customer retention, to minimize customer loss, and to mend mistakes if any.

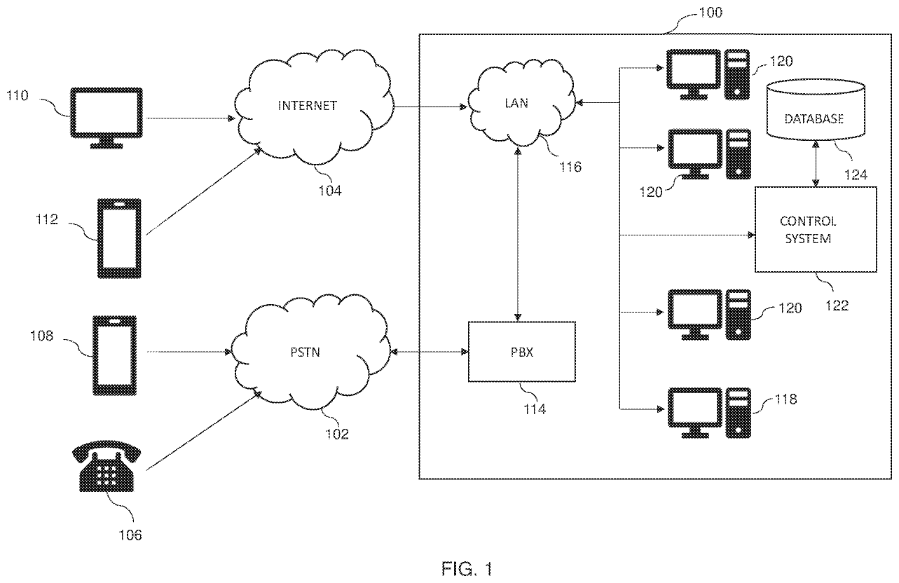

FIG. 1 is a simplified block diagram of an embodiment of a call center 100, such as may be used by a company or organization to handle incoming customer calls or call interactions, according to various aspects of the present disclosure. The call center is just one environment where the methods described herein may be used. The term “call center,” as used herein, can include any facility or system server suitable for receiving and recording phone calls (and other types of oral interactions) from current and potential customers. Call centers can handle inbound and/or outbound calls, and are located either within a company or outsourced to another company that specializes in handling calls. As shown in FIG. 1, the call center 100 of the present disclosure is adapted to receive and record varying electronic communications and data formats that represent an interaction that may occur between a customer (or caller) and an employee of an organization (e.g., a customer service representative) during fulfillment of a customer transaction. In the illustrated embodiment, customers may communicate with employees associated with the call center 100 via multiple different communication networks such as a public switched telephone network (PSTN) 102 or the Internet 104. For example, a customer may initiate an interaction session through traditional telephones 106 or a cellular (i.e., mobile) telephone 108 via the PSTN 102. Further, the call center 100 may accept internet-based interaction sessions from personal computing devices 110 and internet-enabled smartphones 114 and personal digital assistants (PDAs). Internet-based interaction sessions may include web conferencing sessions including those hosted on web conferencing platforms like Zoom, Microsoft Teams, or WebEx.

Call center 100 may receive interactions from PSTN 102 and from Internet 104. Call center has a local area network (LAN) 116 adapted for transfer control protocol over Internet protocol (TCP/IP). LAN 116 supports various employee workstations 120. As shown, each employee workstation 120 includes a LAN-connected computer (PC) and a telephone. In one embodiment, LAN 116 supports at least one manager or supervisor workstation 118. Workstation 118 also include a LAN-connected computer and a telephone connected to switch 114.

In FIG. 1, call center 100 has a telephone switch 114 through which calls are received at the call center and placed from the call center (outbound). Switch 114 may be any type of call center switch including an automatic call distributor (ACD), a soft switch (implemented in software), or a private branch exchange (PBX). In this example, switch 109 is a PBX. PBX switch 114 provides an interface between the PSTN 102 and the LAN within the call center 100. In general, the PBX switch 114 connects trunk and line station interfaces of the PSTN 102 to components communicatively coupled to the LAN 116.

The call center 100 further includes a control system 122 that is generally configured to provide recording, transcription, analysis, storage, and other processing functionality to the call center 100. In the illustrated embodiment, the control system 122 is an information handling system such as a computer, server, workstation, mainframe computer, or other suitable computing device. In other embodiments, the control system 122 may be a plurality of communicatively coupled computing devices coordinated to provide the above functionality for the call center 100. In various embodiments, the control system 122 scores call interactions, generates remarks, and displays the scores and remarks to a supervisor, manager, or leader.

The control system 122 may store recorded and collected data in a database 124 including customer data and employee data. The database 124 may be any type of reliable storage solution such as a RAID-based storage server, an array of hard disks, a storage area network of interconnected storage devices, an array of tape drives, or some other scalable storage solution located either within the contact center or remotely located (i.e., in the cloud).

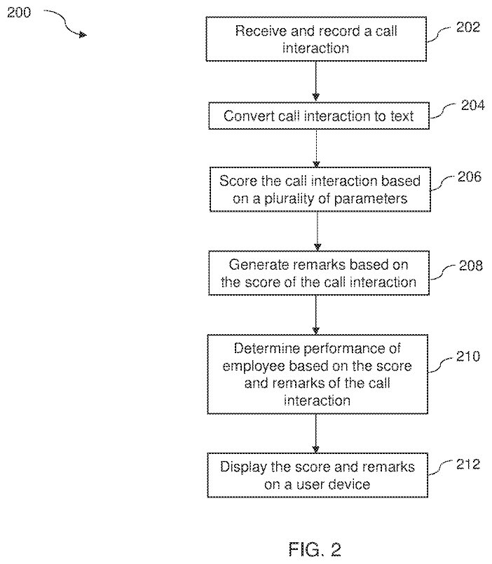

Referring now to FIG. 2, a method 200 for automatically scoring a call interaction is shown. At step 202, control system 122 receives and records a call interaction. The communication type may include one or more voice calls or voice over IP (VoIP), or any other available voice-based communication. In some embodiments, the call interaction may be extracted from an archive or from a storage server.

At step 204, control system 122 transcribes or converts the call interaction to text. In various embodiments, after the call interaction is converted into text, control system 122 determines whether the text was spoken by a customer or an employee of an organization.

At step 206, control system 122 scores the call interaction based on a plurality of parameters. In an exemplary embodiment, the parameters are divided into two categories: (1) what the employee spoke, and (2) how the employee spoke.

What the Employee Spoke

To score what the employee spoke, the following parameters may be evaluated: (1) the number of keywords and phrases used; (2) the number of questions asked; and (3) the quality of the questions asked. This list of parameters serves merely as an example, and additional parameters may be included. In addition, this set of parameters can be defined the same or independently for a sales representative, a customer success manager, a customer support agent for sales calls, client meetings, and support calls. Thus, different types of parameters can be included in the evaluation, and a different importance can be assigned in the scoring discussed below, for different types of users and different types of interactions.

Keywords/Phrases: In certain embodiments, an administrator in a company or organization defines groups of keywords or phrases that an employee is expected to use during a call interaction. Based on the transcription, a text match with keywords and phrases is performed by control system 122. Control system 122 checks how many keywords and phrases the employee spoke. In some embodiments, the number of keywords and phrases spoken is then compared with a predetermined threshold provided by the administrator and a gradient score from 0 to 1 is calculated for this parameter.

Number of Questions: During the call interaction, an employee may ask multiple clarifying and/or discovery-type questions. The answers to these questions can help position the product and services in a personalized manner to the customer, in a customer-facing interaction. The number of such questions asked by the employee constitutes this parameter. The score for this exemplary embodiment is calculated by comparing the number of questions asked by the employee, preferably with predetermined thresholds defined by the product or service, and the resultant score is normalized on a scale of 0 to 1.

Quality of questions: Generally, the administrator in the company or organization separately defines keywords or phrases that the employee should include in the discovery process. This typically comes from the sales methodology the company adopts, and are generally different from the keywords and phrases that an employee is expected to use during a call interaction. This quality of questions parameter checks the nature of the questions the employee is asking by understanding the text of the questions and matching it to the keywords provided by the administrator. In some embodiments, control system 122 can determine what text constitutes a question. For example, the question should start with a “Wh” word (and optionally also the word “How”) and/or should have at least 4 words after a punctuation mark or prior to the question mark. The score for this parameter is calculated by comparing the keywords and phrases only in the questions asked by the employee with the keywords and phrases provided by the administrator to see how the quality of the keywords and phrases compare with a predetermined threshold. The resultant score is normalized on a scale of 0 to 1.

How the Employee Spoke

To score how the employee spoke, the following parameters may be evaluated: (1) the talk/listen ratio; (2) the duration of the longest monologue; (3) the pace of the speech; (4) the number of filler words used; (5) the call length; (6) the number of interchanges; (7) the sentiment deciphered from the call interaction; (8) the call etiquette; (9) the thinking time; and (10) the number of interruptions. This list of parameters serves merely as an example, and additional parameters may be included. In addition, this set of parameters can be defined the same or independently for a sales representative, a customer success manager, a customer support agent for sales calls, client meetings, and support calls.

Talk/Listen Ratio: This parameter looks at how much the employee was talking during the call interaction versus listening to the customer. A good trait of an employee in this model is that he/she maintains a good balance of listening and talking on the call. Too much of either listening or talking can be evaluated as requiring training, if desired. When the control system 122 records and transcribes the call interaction, control system 122 also takes into account who spoke what. Control system 122 can decipher from the metadata (e.g., email and/or name) of the user, whether he/she is an employee of the organization or an external party. With this information, each chunk in the call interaction is not only attributed to a user, but also considered to be external or internal. In various embodiments, the parameter is then determined by considering the ratio of how much the internal team spoke versus listened. The scoring for this parameter is done by comparing the talk:listen ratio with industry standards. The resultant score is then normalized on a scale of 0 to 1.

Duration of Longest Monologue: This parameter looks at how long the employee spoke without having the customer comment or provide feedback. Essentially, in conversations it is difficult to grasp the context if one person keeps talking. A good behavior is defined by having the right breaks in between to seek feedback on what the other party heard so far. In some embodiments, each chunk of the transcription is associated with a person by understanding the tone or through events from web conferencing tools. Control system 122 can look to determine how long (duration) did the employee talk in the call interaction continuously without pausing for feedback and comments. The score for the parameter is calculated by comparing this with predetermined standards or thresholds. The resultant score is normalized on a scale of 0 to 1.

Speech pace: This parameter measures how fast or slow the employee talks. The typical unit of measurement of speech pace is words per minute (wpm). In various embodiments, control system 122 calculates the words per minute spoken by the employee. The score for this parameter is then determined by comparing the wpm of the employee with predetermined standards or thresholds, and the resultant score is normalized on a scale of 0 to 1. For example, the predetermined standard might be selected to have a wpm that is within a specific range, and is neither too high nor too low, to help ensure most customers or other people interacting with the employee can best comprehend the speech.

Number of filler words: This parameter measures how many filler words were mentioned during the call interaction. Examples of filler words include “you know,” “basically,” “I mean,” “okay,” “right,” “so,” and “actually.” From the recording and transcription of the call interaction, filler words used by the employee are identified. The number of filler words used is then compared with predetermined thresholds and standards, and a score for the parameter is derived. The resultant score is then normalized on a scale of 0 to 1.

Call length: This parameter measures how long the total call interaction lasted in, for example, minutes. Based on the recording of the call interaction, control system 122 understands how long the call interaction lasted. The score for this parameter is determined by comparing the call length with predetermined standards or thresholds, and the resultant score is normalized on a scale of 0 to 1.

Number of interchanges: This parameter measures how many times the conversation switched between the two parties during the call interaction. Based on the speaker change that takes place in the conversation, control system 122 determines when there was a significant shift in the conversation. For example, if the employee was speaking a monologue and the customer just responded with OK, this would not constitute an interchange. Only if the customer (who is an external participant) speaks for a sufficient, or considerable, amount of time is that considered an interchange. The number of such interchanges between the employee and the customer are taken into consideration, and the parameter is determined. For scoring purposes, the number of interchanges is compared with predetermined standards or thresholds, and the resultant score is normalized on scale of 0 to 1.

Sentiment: This parameter measures the text sentiment from the call interaction and showcases scores on each sentiment as “anxious,” “sadness,” “temperament,” “hesitation,” “analytical,” “confidence,” or “joy.” In various embodiments, these sentiments are deciphered using IBM's technology to extract text sentiments. In some embodiments, the transcription of the call interaction is submitted to IBM's application program interface (API) to determine the tone of the text. For example, IBM Watson provides the following tones: fear, sadness, anger, tentative, analytical, confidence, and joy. IBM Watson will not, however, always return a score for all 7 parameters. In case a score is not returned for a parameter, then the score is considered as 0. From the result, the count of each sentiment for which a score is returned by IBM, is deciphered. Analytical, confidence, and joy are treated as positive sentiments, while fear, sadness, anger, and tentative are considered as negative sentiments. The sum of the counts of positive sentiments are then divided with the sum of counts of negative and positive sentiments. This provides a score between 0 and 1, which is considered the score of this parameter.

Call etiquette: This parameter determines if the employee followed the right call etiquette, i.e., greeted the customer, set the agenda, then towards the end, mentioned action items/next steps, and concluded the call. From the transcription of the call interaction, the control system 122 determines if the employee mentioned keywords related to greetings and agenda in the initial section of the call as well as if the employee mentioned keywords related to next steps and conclusion towards the final sections of the call. The keywords are compared with the body of knowledge developed in control system 122, which can be pulled from the best practices across customers and research post interviews. The employee is then rated on a scale of 0 to 1 for each aspect—greeting, agenda, next steps, and conclusion by comparing what the employee mentioned with the body of knowledge in control system 122. A weighted average of this is then taken to consider the final score for this parameter on a scale of 0 to 1.

Thinking time: This parameter determines the time the employee takes before responding to the customer. A balanced approach here speaks to the qualities of the conversationalist. From the transcription of the recorded call and the speaker segmentation, control system 122 understands what the internal participant (employee of the company) mentioned and what the external participant (customer) mentioned. Control system 122 now looks at questions asked by the external team and lag between when an external participant spoke and when the internal participant spoke. This time in seconds can be determined across the call interaction and a final average of this time is taken. This constitutes the thinking time of the employee. The score of this parameter is determined by comparing the thinking time of the employee with predetermined standards or thresholds, and the resultant score is normalized to between 0 and 1.

Number of interruptions: This parameter determines the number of times the employee interrupted the chain of thought and talk of the customer as well as the customer's interruptions. The customer's interruption helps determine whether the employee was derailing the conversation and not responding to the question the customer had originally asked. While recording the call interaction, control system 122 can receive the speaker separation events from web conferencing tools (e.g., Zoom, WebEx, or Microsoft Teams). Control system 122 understands if the person talking is the employee of the company (internal participant) or the customer (external participant). Control system 122 now checks if when the external participant was talking, did the internal participant too start talking. Control system 122 can understand this since after a stream of events of the external participant talking, there would come a moment when the events for the internal person talking and external person talking arrive at the same time. This gets counted as an interruption. In normal scenarios, after a stream of events by the external participant, the next set of events from the internal participant would be received. In this manner, overlap is avoided. The number of overlaps that control system 122 deciphers are counted as interruptions. The score for this parameter is calculated by comparing these interruptions with predetermined standards/thresholds, and the resultant score is normalized to between 0 and 1.

In certain embodiments, control system 122 scores each of the parameters by comparing the value of each of the parameters with industry standards, targets, benchmarks, or thresholds. In various embodiments, the industry standards, targets, benchmarks, or thresholds are determined through a combination of inputs from the company or organization and industry (e.g., best practices in the industry), and in a preferred embodiment the scores are calculated in a gradient manner. In another embodiment, the scores are calculated in a step-based manner. For example, a step-based threshold or target may award a score of 0 for a call length of less than 25 minutes or a call length of more than 70 minutes, and award a score of 1 for a call length of 25 to 70 minutes. If an employee had a meeting that was 24 minutes long, the employee would receive a score of 0 for call length using the step-based threshold. In contrast, for a gradient-based threshold or target for call length, the score would be determined based on where 24 minutes falls on a bell curve based on predetermined or preset thresholds for a desired call length. For example, the employee would receive a score of 0.3 for a 24-minute call in this example, rather than a score of zero.

In one embodiment, with respect to sales calls, predetermined targets, thresholds or benchmarks could be specific to certain sales parameters such as sales stages, such that in stage 1 of the sales transaction, the benchmark could be 70% and for stage n, it could be 50%. Advantageously, control system 122 can accommodate this flexibility.

According to several embodiments, once each parameter in the category of “what the employee spoke” and “how the employee spoke” are scored, control system 122 calculates an overall score for the employee. In various embodiments, the overall score for each category is determined by a weighted average of all parameters in that category. In some embodiments, control system 122 aggregates the scores across all call interactions for a company or organization for call interaction analytics.

In certain embodiments, administrators of a company or organization are allowed the define the distribution of weight for each parameter. At the same time, control system 122 understands the behaviors of the top performers based on their outcomes (e.g., number of deals closed or number of support cases closed), and provides this data to the administrator to update the weights. In some embodiments, control system 122 can also change the weight based on critical information such as “sales stages,” in case of sales calls, thereby defining a set of weights for stage 1 and a separate set of weights for stage n.

Table 1 below provides an example of weight distribution, taking into account a sales call by a sales representative.

TABLE 1
EXAMPLE OF WEIGHT DISTRIBUTION

| | Weight of | Parameter | Weight of |
|---|---|---|---|
| Category | Category | | Parameter |
| What the sales | 50% | Keywords/ Phrases | 34% |
| rep spoke | | mentioned and not | |
| | | mentioned | |
| | | Number of questions asked | 33% |
| | | Quality of questions asked | 33% |
| How the sales | 50% | Talk:Listen ratio | 20% |
| rep spoke | | Duration of longest | 10% |
| | | monologue | |
| | | Speech pace | 5% |
| | | Number of filler words used | 5% |
| | | Call length | 5% |
| | | Number of interchanges | 10% |
| | | Sentiment deciphered from | 10% |
| | | the call | |
| | | Call etiquettes | 10% |
| | | Thinking time | 15% |
| | | Number of interruptions | 10% |

In various embodiments, control system 122 calculates a final score of the call interaction. For example, this can be determined by a weighted average of the category scores. In one embodiment, the final score can be calculated as follows:

Overall score of what sales representative spoke=[(weight of number of keywords/phrases mentioned*parameter score of number of keywords/phrases)+(weight of number of questions asked*parameter score of number of questions asked)+(weight of quality of questions asked*parameter score of quality of questions asked)]/100

Overall score of how sales representative spoke=[(weight of talk/listen ratio*parameter score of talk/listen ratio)+(weight of duration of longest monologue*parameter score of duration of longest monologue)+(weight of speech pace*parameter score of speech pace)+(weight of number of filler words used*parameter score of filler words used)+(weight of call length*parameter score of call length)+(weight of number of interchanges*parameter score of number of interchanges)+(weight of sentiment deciphered*parameter score of sentiment deciphered)+(weight of call etiquette*parameter score of call etiquette)+(weight of thinking time*parameter score of thinking time)+(weight of number of interruptions*parameter score of number of interruptions)]/100

Final score of call=[(weight of what sales representative spoke*overall score of what sales representative said)+(weight of how sales representative spoke*overall score of how sales representative spoke)]/100

At step 208, control system 122 generates remarks based on the final score of the call interaction. For example, Table 2 below provides an example of remarks that are generated based on the final score.

TABLE 2
EXAMPLE OF REMARKS

| Final Call Score | Remark |
|---|---|
| ≤0.4 | Needs improvement |
| >0.4 and ≤0.7 | Moderate |
| >0.7 and ≤0.85 | Good |
| >0.85 | Excellent |

In some embodiments, control system 122 generates one or more remarks for each parameter. As explained above, each parameter is measured and compared with a predetermined benchmark, target, threshold, or standard to generate a parameter score. In some embodiments, depending on the parameter, the closer the value the parameter is to the threshold, the higher the score. In other embodiments, depending on the parameter, the parameter should exceed the threshold, and the farther away the parameter is from the threshold, the higher the score. Based on the variance of the parameter from the predetermined benchmark, threshold, or standard, one or more remarks are generated for each parameter. For example, Table 3 below shows how speech pace may be scored and how remarks may be generated.

TABLE 3
SCORING OF SPEECH PACE
AND ASSOCIATED REMARKS

| | Parameter | |
|---|---|---|
| Threshold | Score | Remark |
| <120 words/min | 0 | The sales representative |
| of talk time | | spoke too slow |
| >160 words/min | 0 | The sales representative |
| of talk time | | spoke too fast |
| Else | 1 | Appropriate speech pace |

In certain embodiments, additional remarks are generated. For example, in Table 3 above, a remark of “needs improvement” may be included for the sales representative who spoke too slowly and the sales representative that spoke too quickly so that a leader or manager can readily determine which employees need coaching or training. Other possible additional remarks include “needs training,” “needs coaching,” or “requires improvement.” These additional remarks may also accompany any parameter where a threshold has not been met (or has been exceeded), or where a score for a parameter is too close to a threshold, such as by a preset percentage or absolute value.

At step 210, control system 122 determines the performance of the employee based on the score and remarks of the call interaction. For example, an employee may be determined to have excellent performance if his/her final score is greater than 0.85, or an employee may be determined to have poor performance if her/her final score is less than 0.4. In various embodiments, it may be desired only to have a lower or upper value to be exceeded, or approached.

At step 212, control system 122 displays the score and the remarks for the call interaction on a user device to improve the performance of the employee.

In various embodiments, a user (e.g., a manager, leader, trainer, sales representative, or customer success agent) can log in to an application and can review the data associated with the call interactions. In one embodiment, after the user logs in to the application, the user can access a graphical user interface (GUI) to sees a list of call interactions with remarks. The user can sort or filter the call interactions based on the remarks. For example, the user can choose to see only those call interactions with the remarks “needs improvement.” In certain embodiments, the remarks are color-coded (e.g., “needs improvement” remarks may be color-coded red) so the user can more easily review all of the call interactions that are color-coded red. Moreover, any other desired priority system of color-coding may be used, such as yellow for potential concerns and red for problems requiring attention. Alternatively, other designation systems may be used, such as font sizing, italics/bold/underlining, etc. to help distinguish problems with a different appearance from general text, e.g., by using a larger sized font coupled with underlining and bold, etc. Once the user sees the call interactions with the selected remarks, the user can hover a cursor over the call interaction to get a quick glimpse of the score and the areas of the call interaction that need improvement (e.g., the parameters having low scores). In some embodiments, the user can select a specific call interaction by clicking on the call interaction to get the details and remarks for each parameter. In this way, the user realizes which areas in the company need improvement and further employee action may be taken, such as training, coaching, informal correction, or the like.

In another embodiment, a user can log in to the application, and obtain a quick summary of the scores across all call interactions for an employee. Advantageously, the user is able to see the data across each parameter aggregated across all call interactions for the employee. The user is also able to click on any parameter and get a list of call interactions with data for that parameter. In some embodiments, the user can click on a specific call interaction and listen for further context. In this way, the user realizes areas of strength and improvement for the employee, and is able to coach or train the employee better. In several embodiments, the user can perform a search, use one or more pre-set filter options to conduct a search, or both, to focus on a particular score or parameter, then optionally filter the results further, and sort the results based on an overall or individual parameter score to more easily narrow the list of call interactions for review.

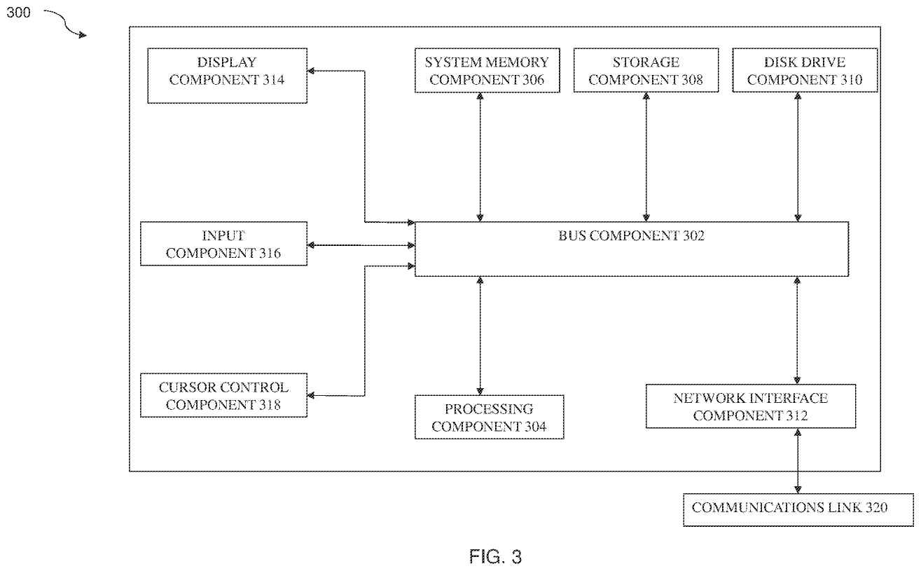

Referring now to FIG. 3, illustrated is a block diagram of a system 300 suitable for implementing embodiments of the present disclosure, including control system 122 and workstations 118, 120. System 300, such as part a computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to receive and record a call interaction between a customer and an employee of an organization; convert the call interaction into text; score the call interaction based on a plurality of parameters associated with what the employee spoke and how the employee spoke; generate remarks based on the score of the call interaction; determine performance of the employee based on the score and the remarks of the call interaction; and display the score and remarks of the call interaction on a user device to improve the performance of the employee. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., networks 102 or 104 of FIG. 2, LAN 116, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A system comprising:
a processor and a computer readable medium operably coupled thereto, the computer readable medium comprising a plurality of instructions stored in association therewith that are accessible to, and executable by, the processor, to perform operations which comprise:
receiving and recording a call interaction between a customer and an employee of an organization;
converting the call interaction into text;
automatically scoring the call interaction based on a plurality of parameters associated with what the employee spoke and a plurality of parameters associated with how the employee spoke;
generating remarks based on the score of the call interaction;
determining performance of the employee based on the score and the remarks of the call interaction; and
displaying the score and the remarks of the call interaction on a user device to improve the performance of the employee.

2. The system of claim 1, wherein the call interaction comprises a sales call, a client meeting, a webinar, or a customer service call.

3. The system of claim 1, wherein the operations further comprise determining whether the text was spoken by the customer or by the employee.

4. The system of claim 1, wherein the plurality of parameters associated with the what the employee spoke comprise two or more of: a number of keywords/phrases used; a number of questions asked; or a quality of questions asked.

5. The system of claim 1, wherein the plurality of parameters associated with how the employee spoke comprise two or more of: a talk/listen ratio; a duration of a longest monologue; a speech pace; a number of filler words used; a call length; a number of interchanges; a sentiment deciphered from the call interaction; a call etiquette; a thinking time; or a number of interruptions.

6. The system of claim 1, wherein scoring the call interaction comprises calculating a final score for the call interaction by:
calculating an overall score for the plurality of parameters associated with what the employee spoke and multiplying the overall score for the plurality of parameters associated with what the employee spoke by a predetermined weight to yield a weighted overall score for the plurality of parameters associated with what the employee spoke;
calculating an overall score for the plurality of parameters associated with how the employee spoke and multiplying the overall score for the plurality of parameters associated with how the employee spoke by a predetermined weight to yield a weighted overall score for the plurality of parameters associated with how the employee spoke; and
adding the weighted overall score for the plurality of parameters associated with what the employee spoke to the weighted overall score for the plurality of parameters associated with how the employee spoke to yield the final score.

7. The system of claim 6, wherein:
calculating the overall score for the plurality of parameters associated with what the employee spoke comprises determining a weight for each parameter of the plurality of parameters associated with what the employee spoke; and
calculating the overall score for the plurality of parameters associated with how the employee spoke comprises determining a weight for each parameter of the plurality of parameters associated with how the employee spoke.

8. The system of claim 7, wherein:
calculating the overall score for the plurality of parameters associated with what the employee spoke further comprises computing a parameter score for each parameter of the plurality of parameters associated with what the employee spoke by comparing a value of each parameter to a predetermined threshold or target, wherein the predetermined threshold or target is determined through a combination of inputs from the organization and best practices in the industry, and the parameter score for each parameter of the plurality of parameters associated with what the employee spoke is calculated in a gradient manner; and
calculating the overall score for the plurality of parameters associated with how the employee spoke further comprises computing a parameter score for each parameter of the plurality of parameters associated with how the employee spoke by comparing a value of each parameter to a predetermined threshold or target, wherein the predetermined threshold or target is determined through a combination of inputs from the organization and best practices in the industry, and the parameter score for each parameter of the plurality of parameters associated with how the employee spoke is calculated in a gradient manner.

9. The system of claim 8, wherein:
calculating the overall score for the plurality of parameters associated with what the employee spoke further comprises multiplying the determined weight for each parameter by its respective computed parameter score to yield a product for each parameter, and adding the products for each parameter to arrive at the overall score of what the employee spoke; and
calculating the overall score for the plurality of parameters associated with how the employee spoke further comprises multiplying the determined weight for each parameter by its respective computed parameter score to yield a product for each parameter, and adding the products for each parameter to arrive at the overall score of how the employee spoke

10. The system of claim 9, wherein:
a plurality of call interactions are received and recorded for the organization;
each of the plurality of call interactions are converted into text; and
each of the call interactions are scored; and
wherein the operations further comprise aggregating the scores of the plurality of call interactions for the organization.

11. A method of automatically scoring a plurality of call interactions, which comprises:
receiving and recording a call interaction between a customer and an employee of an organization;
converting the call interaction into text;
scoring the call interaction based on a plurality of parameters associated with what the employee spoke and a plurality of parameters associated with how the employee spoke;
generating remarks based on the score of the call interaction;
determining performance of the employee based on the score and the remarks of the call interaction; and
displaying the score and the remarks of the call interaction on a user device to improve the performance of the employee.

12. The method of claim 11, wherein the plurality of parameters associated with the what the employee spoke comprise two or more of: a number of keywords/phrases used; a number of questions asked; or a quality of questions asked.

13. The method of method of 11, wherein the plurality of parameters associated with how the employee spoke comprise two or more of: a talk/listen ratio; a duration of a longest monologue; a speech pace; a number of filler words used; a call length; a number of interchanges; a sentiment deciphered from the call interaction; a call etiquette; a thinking time; or a number of interruptions.

14. The method of claim 13, wherein scoring the call interaction comprises calculating a final score for the call interaction by:
calculating an overall score for the plurality of parameters associated with what the employee spoke and multiplying the overall score for the plurality of parameters associated with what the employee spoke by a predetermined weight to yield a weighted overall score for the plurality of parameters associated with what the employee spoke;
calculating an overall score for the plurality of parameters associated with how the employee spoke and multiplying the overall score for the plurality of parameters associated with how the employee spoke by a predetermined weight to yield a weighted overall score for the plurality of parameters associated with how the employee spoke; and
adding the weighted overall score for the plurality of parameters associated with what the employee spoke to the weighted overall score for the plurality of parameters associated with how the employee spoke to yield the final score.

15. The method of claim 14, wherein:
calculating the overall score for the plurality of parameters associated with what the employee spoke comprises:
determining a weight for each parameter of the plurality of parameters associated with what the employee spoke;
computing a parameter score for each parameter of the plurality of parameters associated with what the employee spoke by comparing a value of each parameter to a predetermined threshold or target, wherein the predetermined threshold or target is determined through a combination of inputs from the organization and best practices in the industry, and the parameter score for each parameter of the plurality of parameters associated with what the employee spoke is calculated in a gradient manner;
multiplying the determined weight for each parameter by its respective computed parameter score to yield a product for each parameter; and
adding the products for each parameter to arrive at the overall score of what the employee spoke.

16. The method of claim 14, wherein:
calculating the overall score for the plurality of parameters associated with how the employee spoke comprises:
determining a weight for each parameter of the plurality of parameters associated with how the employee spoke;
computing a parameter score for each parameter of the plurality of parameters associated with how the employee spoke by comparing a value of each parameter to a predetermined threshold or target, wherein the predetermined threshold or target is determined through a combination of inputs from the organization and best practices in the industry, and the parameter score for each parameter of the plurality of parameters associated with how the employee spoke is calculated in a gradient manner;
multiplying the determined weight for each parameter by its respective computed parameter score to yield a product for each parameter; and
adding the products for each parameter to arrive at the overall score of how the employee spoke.

17. A non-transitory computer-readable medium having stored thereon computer-readable instructions executable by a processor to perform operations which comprise:
receiving and recording a call interaction between a customer and an employee of an organization;
converting the call interaction into text;
scoring the call interaction based on a plurality of parameters associated with what the employee spoke and a plurality of parameters associated with how the employee spoke;
generating remarks based on the score of the call interaction;
determining performance of the employee based on the score and the remarks of the call interaction; and
displaying the score and the remarks of the call interaction on a user device to improve the performance of the employee.

18. The non-transitory computer-readable medium of claim 17, wherein the plurality of parameters associated with what the employee spoke comprise two or more of: a number of keywords/phrases used; a number of questions asked; or a quality of questions asked.

19. The non-transitory computer-readable medium of claim 17, wherein the plurality of parameters associated with how the employee spoke comprise two or more of: a talk/listen ratio; a duration of a longest monologue; a speech pace; a number of filler words used; a call length; a number of interchanges; a sentiment deciphered from the call interaction; a call etiquette; a thinking time; or a number of interruptions.

20. The non-transitory computer-readable medium of claim 17, wherein scoring the call interaction comprises calculating a final score for the call interaction by:
calculating an overall score for the plurality of parameters associated with what the employee spoke and multiplying the overall score for the plurality of parameters associated with what the employee spoke by a predetermined weight to yield a weighted overall score for the plurality of parameters associated with what the employee spoke;
calculating an overall score for the plurality of parameters associated with how the employee spoke and multiplying the overall score for the plurality of parameters associated with how the employee spoke by a predetermined weight to yield a weighted overall score for the plurality of parameters associated with how the employee spoke; and
adding the weighted overall score for the plurality of parameters associated with what the employee spoke to the weighted overall score for the plurality of parameters associated with how the employee spoke to yield the final score.
